(19) United States
(12) Patent Application Publication
(10) Pub. No.: US 2004/0134588 A1
(43) Pub. Date: Jul. 15, 2004

(54) Method for the manufacture of a molded body firmly bonded to a grained or structured molded skin and a device for performing the method

(76) Inventors: Andreas Gerken, Hannover (DE); Gunter Vogt, Rinteln (DE)

Correspondence Address: WILLIAM COLLARD, COLLARD & ROE, P.C., 1077 NORTHERN BOULEVARD, ROSLYN, NY, 11576, US

(21) Appl. No.: 10/716,128

(22) Filed: Nov. 18, 2003

(30) Foreign Application Priority Data
Nov. 19, 2002 (DE) 102 53 725.9

(51) Int. Cl. B29C 44/12

(52) U.S. Cl. 156/78; 264/46.4; 156/219; 156/245; 156/501; 156/500; 264/225

(57) ABSTRACT

A method for producing a molded body firmly bonded to a grained molded skin by inserting a spatially conformed, elastic skin having a graining or structuring on the inside into a receiving mold open on one side of a tool bottom part. A liquid plastic film that forms the molded skin after hardening is then applied to the grained inside of the elastic skin. The molded skin is then back-foamed, the foamed plastic firmly bonding with the molded skin. Subsequently, the entire assembly of elastic skin, molded skin, and molded body is removed from the receiving mold of the tool bottom part. Finally, the elastic skin is stripped away from the molded skin that is firmly bonded to the molded body, a graining or structuring remaining on the surface of the molded skin.

### BACKGROUND OF THE INVENTION

1. Field of the Invention

The invention relates to a method for manufacturing a molded body firmly bonded to a grained or structured molded skin, and a device for the performance of such a method.

2. The Prior Art

Numerous procedures and devices are known for the manufacture of a molded body firmly bonded to a grained or structured molded skin, especially by molded skins that have been back-foamed or back-foamed and provided with a support.

All known devices and methods for the manufacture of a molded body firmly bonded to a grained or structured molded skin are associated with complex handling and high costs. In particular, many machines and tools must be maintained, and these frequently cannot guarantee a uniform quality standard in the manufacture of the molded body firmly bonded to a grained or structured molded skin. In particular, it has been shown that the quality or value requirement of the visible graining or structuring of the molded skin is not reproducible due to the use of unsuitable tools. Moreover, the graining or structuring of the molded skin is often damaged, especially when the grained or structured molded skin is transported or is bonded with a molded body and is removed from the tool that is used either alone with the molded body. This gives rise to flawed, unusable products, which in turn result in high costs. The design possibilities for the molded body that is firmly bonded with the grained or structured molded skin are also extremely limited with the methods and tools currently in use. Modifications to the design can only be achieved with time-consuming and expensive re-configuration of the tools and/or by constructing an entirely new set of tools.

U.S. Pat. No. 5,116,557, for example, describes a method for the manufacture of three-dimensional molded skins, in which a liquid, reactive polyurethane mixture is sprayed onto the surface of a pre-fabricated metal form and may be provided with an additional polyurethane foam and additional rigid supports. The drawback of this method is that complicated geometrical components, particularly those with undercuts, can only be created through the use of multi-part tool dies, and the boundary lines of the various tool components are indented in the surface of the molded skin. These boundary lines become more and more prominent with increasing wear of the tool. It is a further disadvantage that in order to be able to release the molded skin produced by spraying the liquid polyurethane without damaging it, a separating agent must typically be applied to the metal die after the polyurethane has hardened. The separating agent then also further impairs the quality and aesthetic appearance of the molded skin surface in that the surface exhibits an unnatural or uneven shine.

The same drawbacks occur with a method known from U.S. Pat. No. 5,662,996 for manufacturing a molded body that is firmly bonded with a polyurethane skin. In this method, first an elastomer polyurethane molded skin is produced according to the spray process described in U.S. Pat. No. 5,116,557. This polyurethane molded skin is then provided with a polyurethane foam and finally, with a rigid support, the support being formed by a two-component polyurethane system.

German Patent No. DE 43 21 920 A1 describes a method for manufacturing polyurethane cast skins, which may be provided with a foam and a rigid support material. This method can be performed in only one receiving mold of a tool bottom part, which saves considerable expenses in terms of tools. In this case, however, the production of geometrically demanding components, for example with undercuts, is only possible if multi-part tools are used. But under these conditions, pressure points from the tools leave unsightly ridges on the surface of the polyurethane cast skin. A further disadvantage in this connection also is that separating agents must typically be used in order to be able to detach the part from the receiving mold in the tool bottom part. However, the use of a separating agent negatively affects the desired degree of shine on the surface. The visible impact ridges also mean that the design possibilities for the visible side of the polyurethane cast skin are considerably limited.

German Patent No. DE 100 59 762 A1 describes a procedure in which a decorative skin, particularly a slush skin, is foamed without pressure in a form tool and provided with a support. One advantage of this method is that it requires no change of the form tool. On the other hand, it is not possible to create sophisticated geometrical undercuts, such as usually occur with instrument panels, the rigid component cannot be removed from the tool. Ejectors may be used for this purpose, such as those described in German Patent No. DE 100 22 646 A1 for example, but this results in serious design and construction limitations.

### SUMMARY OF THE INVENTION

It is therefore an object of the invention to improve the method described above so that a molded body firmly bonded to a grained or structured molded skin may be produced economically with the use of as few tools as possible, while providing more design possibilities not only with regard to the graining or structuring of the molded skin but also in terms of the geometrical shape of the finished molded body firmly bonded to the molded skin. In particular, the procedure should be improved such that newly developed or changed designs of the molded skin and of the molded body firmly bonded therewith may be realized in practice more quickly, without extensive alterations to the tools being used.

It is another object of the invention to improve the method of the type described above so that the finished molded bodies bonded firmly with the molded skins exhibit a uniform and improved quality and value requirement, particularly with regard to their visible graining or structuring.

It is yet another object of the invention to suggest a device for performing such method, which enables numerous design possibilities of the molded firmly bonded to a grained or structured, molded skin, without the need to carry out labor-intensive re-tooling.

It is a further object of the invention to provide a molded body firmly bonded to a grained or structured molded skin, which may be manufactured in reproducible manner and exhibits improved quality and value requirements, particularly in terms of the visible graining or structuring.

These objects are achieved according to the invention in a method for producing a molded body firmly bonded to a grained or structured molded skin having the following characteristics:

a) Insertion of a spatially conformed, elastic skin, having a graining-or structuring on the inside thereof, into a receiving mold open on one side of a tool bottom part in such manner that the outside of the elastic skin abuts the inner wall of the receiving mold and is stabilized thereby,

b) Application of a liquid plastic film with a predefined film thickness to the grained or structured inside of the elastic skin,

c) Hardening of the plastic film, so that the molded skin is formed;

d) Back-foaming of the molded skin to form the molded body and a firm bond between the molded body and the molded skin by introducing suitable reactive foaming agents into an intermediate space, which is delimited by the inside of the molded skin and a spatially conformed tool top part, which is inserted into the receiving mold of the tool bottom part, the dimensions of the intermediate space, and thus also of the foam that forms the molded body, being defined by the contours of the molded skin and the tool top part, and the intermediate space being sealed off from the tool top part during the foaming process,

e) Removal of the entire assembly of elastic skin, molded skin, and the molded body from the receiving mold of the tool bottom part, the tool top part being removed either before or after the removal of the entire assembly, and

f) Stripping of the elastic skin from the molded skin, which is firmly bonded with the molded body, a graining or structuring remaining on the surface of the molded skin after the elastic skin is stripped away.

With the method according to the invention, the molded body bonded firmly with a grained or structured molded skin may be produced in an economic fashion with only one receiving mold of a tool bottom part, and in which the insertion of the spatially conformed, elastic skin into the receiving mold allows greater design possibilities regarding the graining or structuring of the molded skin and in terms of the geometrical design of the finished molded body bonded firmly with a grained or structured molded skin.

The spatially conformed, elastic skin abuts the inner wall of the receiving mold and the specific design of the inner wall of the receiving mold does not have a negative effect on the design possibilities described, since any edges that may be present, for example of sliders, flaps or ejectors that are disposed in the receiving mold of the lower tool part do not leave traces on the molded skin. This is entirely prevented by the spatially conformed, elastic skin which is inserted into the receiving mold.

A receiving mold of the tool bottom part used in the method according to the invention may be adapted very quickly to different contours of the spatially conformed, elastic skin. This in turn provides the ability to produce geometrically sophisticated molded bodies bonded firmly with the molded skin, which particularly may include complicated undercuts. Particularly advantageous on this point however is that newly developed or changed designs of the molded skin and of the molded body firmly bonded thereto may be implemented more quickly, without the need for labor-intensive modifications to the tools being used.

Moreover, with the method according to the invention it is possible to achieve improved quality and value in the molded body bonded firmly to the molded skin, particularly with regard to the visible graining or structuring thereof. The use of a separating agent is no longer necessary.

The manufacture of a spatially conformed, elastic skin as a negative model is known from German Patent No. DE 39 13 157 C2. In this method, the elastic skin is produced by a spraying robot on a working model and is subsequently removed therefrom. Then, the elastic skin, which has graining on its inside, is turned inside out so that the graining appears on the outside. In particular, the purpose is to allow better access to tight curves and undercuts for the spray robot, which sprays a polyurethane paint coat in the “In Mold Coating” process and thereafter a supporting polyurethane molded skin on the grained side of the elastic skin. The disadvantage of this procedure is that because of the double reversal and removal of this two-ply molded skin from the elastic skin, only one molded skin is obtained, which is typically firmly bonded to a molded body in other tools. It has further been revealed that the reversal and double reversal of the elastic skin causes distortions and buckling not only in the elastic skin but also in the molded skin, which is especially noticeable in tight curves and undercuts. The manufacture of an unstressed molded skin is not possible according to this known procedure.

The same applies for a method described in German Patent No. DE 41 29 777 A1 for producing a spatially conformed and optionally grained, molded skin from a plastic that hardens but remains-flexible in the final condition, particularly form polyurethane, as a covering for laminated interior vehicle fittings that are to be foamed in pack, particularly for instrument panels. With such a method, a liquid plastic is sprayed with a desired thickness onto an elastic skin corresponding in negative form to the molded skin. The elastic skin is occasionally turned outwards while the plastic film is being sprayed in the area of undercuts and/or sharp recesses. After the plastic has been applied, the elastic skin is turned inside in again before the plastic hardens. After the plastic has hardened, the finished molded skin is removed for further use.

The method according to the invention has the particular advantage that the surface of the mold body is protected until the last procedure step by the elastic skin. Thus it is possible to reliably prevent damage to the surface such as occurs for example when the molded skins are being transported or during separate foaming of the molded skins. This guarantees both uniform quality and less waste, so that overall costs may be reduced.

It is also advantageous that the molded skin produced initially may be foamed without changing the receiving mold. In conventional nickel electroforming molds, which are normally used in the manufacture of slush and spray molded skins, this is only possible to a limited degree. Particularly disadvantageous is the fact that defective slush or mold skins can cause “foam penetration,” in which the electroforming molds are contaminated and require relatively labor-intensive cleaning operations. This cannot occur with the method according to the invention.

The application of a liquid plastic film in a predefined film thickness to the grained or structured inside of the elastic skin as described in step b) of the method according to the invention may be performed by known slush or molding processes. In this context, the term liquid plastics is also understood to include plastics in the molten state. One refinement of the invention provides that the tool upper part used in step d) of the method includes a detachable and spatially conformed support, which at least partially delimits the intermediate space instead of the tool upper part, the dimensions of the intermediate space being determined by the contours of the molded skin and at least partially by the support disposed on the tool upper part rather than by the tool upper part itself, and that in process step e) the entire assembly of elastic skin, molded skin and molded body with embedded support is removed from the receiving mold of the tool bottom part, the tool upper part being detached and removed from the support either before or after the entire assembly is withdrawn.

Suitable reactive foaming agents include such starting materials that form open-cell polyurethane foams.

The foaming process preferably takes place with the application of heat, and the tool top part preferably heated for this purpose via at least one a heating channel extending in the tool top part.

The method according to the invention preferably consists of the following steps:

a) Insertion of a spatially conformed, elastic skin, having a graining or structuring on the inside thereof, into a receiving mold of a tool bottom part that is open on one side, in such a manner that the outside of elastic skin abuts the inner wall of receiving mold and is stabilized by the inner wall,

b) Application of a liquid plastic film with a predefined film thickness to the grained or structured inside of the elastic skin,

c) Hardening of the plastic film, the molded skin being formed thereby,

d) Bonding of a molded body configured as a support to the molded skin such that a primer and/or adhesive is applied to the inside of the molded skin and the support as a detachable part of a tool top part is pressed by the tool top part onto the molded skin, to which the primer and/or adhesive has been applied, thereby forming a firm bond between support and molded skin,

e) Removal of the entire assembly of elastic skin, molded skin, and the molded body from the receiving mold of the tool bottom part, the tool top part being detached and removed from the molded body configured as the support either before or after removal of the entire assembly, and

f) Stripping of the elastic skin from the molded skin, which is firmly bonded to the molded body, a graining or structuring remaining on the surface of the molded skin after the elastic skin has been stripped away.

An improvement of the invention provides that the mold body arranged as the support is not bonded with the molded skin in as in process steps c) and d), but in such manner that the support is as a detachable part of the tool top part is pressed by the tool top part onto the plastic film before it has completely hardened, a firm bond between the support and the molded skin only being established when the plastic film has fully hardened.

In an advantageous refinement of the invention, the elastic skin that is stripped away in process step f) is reused directly in process step a).

The liquid plastic film is preferably applied with a pre-determined film thickness to the grained or structured inside of the elastic skin by pouring or injecting liquid plastic into an intermediate space that is delimited by the inside of the elastic skin and by a spatially conformed tool top part inserted into the receiving mold of the tool bottom part, the dimensions of the intermediate space being determined by the contours of the elastic skin and the tool top part. The tool top part is then withdrawn from the receiving mold of the tool bottom part after at least partial hardening of the plastic film.

In this way, the molded skin produced has reproducible film thicknesses, particularly in the area of undercuts. The molded skins may be produced without stress in this way, so that the molded bodies bonded firmly with a molded skin satisfy a uniform quality standard.

The plastic film is preferably hardened with the effects of heating, for which purpose the tool top part is heated via at least one heating channel extending along the tool top.

This is particularly advantageous since a heating effect is reduced in the tool bottom part because of the poor heat conduction of the elastic skin.

The plastic film is preferably formed from cross-linkable polyurethanes preferably polyurethane casting resins, liquid and cross-linkable organic resins, preferably epoxy resins or non-reactive molten masses, preferably thermoplastic polyurethanes (TPU), thermoplastic polyolefins (TPO), thermoplastic elastomers (TPE), polyvinyl chloride (PVC) or mixtures of these masses.

In a refinement of the invention for forming the plastic film, a single or multi-component cross-linkable polyurethane system is used that is preferably based on aliphatic or especially based on aromatic starting materials.

According to a practical embodiment of the invention, a thin layer of paint is applied to the grained inside of the elastic skin after performance of process step a) in a process known as “In Mold Coating,” and is dried or hardened. Process step b) follows, in which the liquid plastic film is no longer applied directly to the inside of the elastic skin but rather to the thin layer of paint.

The surface properties of the molded skin, especially regarding its durability or its surface and grained appearance, are improved by “In-Mold-Coating.”

In a further refinement, different zones of the inside of the elastic skin are coated with different-colored paints.

The above task is resolved according to the invention with a device for the performance of the method according to the invention, in that the spatially conformed and elastic skin, which has a graining or structuring on its inside, is a flexible elastomer polyurethane or rubber skin, preferably a flexible silicone skin.

Silicone skins are distinguished by their especially good resistance to pressure and heat. In particular, it has been demonstrated that certain silicone skins have extremely long service lives in molding processes using rollers.

However, the combination of silicone skins and “In Mold Coatings” also enables unique examples of highly-contoured and high-quality graining profiles to be created in advantageous manner, for example velour grains, which with the current art cannot be produced or can be produced only with great difficulty on the surface of three-dimensional constructions such as instrument panels. The recreation of multicolored parts with a greater variety of graining patterns than is offered by conventional molded skin production methods is possible with the present invention.

Reinforcing elements can be arranged in the elastic skin and are preferably made from fabric, plastic, textile or glass fibers, thus increasing the deformation resistance thereof.

The spatially conformed, elastic skin may be produced by cross-linking a liquid silicone prepolymer in an addition and/or condensation reaction after it has been applied to a grained or structured positive model, and then detaching it from the positive model, so that the elastic silicone skin reflects the spatially conformed negative image of the molded skin to be produced in process steps b) and c) and is furnished with a corresponding graining or structuring on its inside.

A silicone skin produced in this fashion includes sufficient information about the contour, the grain or the structuring, and where appropriate about the sheen of the molded skin that is to be produced, firmly bonded to a molded body. This casting process may be performed cheaply and quickly. Rejected silicone skins may therefore be quickly replaced.

The spatially conformed, elastic silicone skin may preferably be produced by removing enough of the silicone from the outside of the silicone skin that has been detached from the positive model until a pre-defined layer thickness of the silicone skin is obtained.

Alternatively, the spatially conformed, elastic silicone skin may be produced by introducing the liquid silicone prepolymer into an intermediate space in a closed tool, which space is delimited by a tool top part reflecting the positive model and by a spatially conformed tool bottom part that may be placed over the positive model, the dimensions of the intermediate space being determined by the contours of the tool bottom part and the tool top part, and by cross-linking after the silicone prepolymer has been introduced into the intermediate space.

Silicone skins produced in this way possess very high reproduction fidelity and may be produced in large quantities. An essential feature is that the reproducible silicone skins may be produced with the same layer thickness, since this has direct implications for uniform quality of the molded body firmly bonded with the grained or structured molded skin to be manufactured.

In an advantageous configuration of the invention, the elastic skin has a layer thickness between 0.8 and 10 mm, preferably between 1 and 6 mm.

The effect of this is that any edges which may be present on the inner wall of the receiving mold of the tool bottom part do not leave marks on the surface of the molded skin furnished with graining or structuring, despite the pressure exerted on the inner wall, for example during back-foaming of the molded skin.

The tool bottom part is constructed of multiple and/or movable components, particularly including sliders, flaps or ejectors. This enables the tool bottom part to be adapted to various contours of the elastic skins used. As a result, it is not necessary to maintain a large number of tools. This saves considerable tooling expenses. Moreover, the range of design possibilities is vast, since according to the invention, no edges of the movable components leave marks on the molded skin of the finished molded body. Thus, it is also possible to produce molded bodies with sophisticated geometrical shapes and complicated undercuts.

This also provides for a considerably easier method of ejecting a manufactured molded body. Until now, this has not been possible for sophisticated geometrical contours, particularly in the area of undercuts, without leaving visible traces, for example of separation and slider lines. As a result, in the method according to the invention, more design possibilities are provided by a designer. In this respect, the method according to the invention differs significantly from conventional procedures that also use only one receiving mold in the tool bottom part for the manufacture of a molded body firmly bonded with a grained or structured molded skin.

The tool top parts have a multiple-part construction and/or include movable components, particularly sliders, flaps or ejectors. In this way, desired contours and dimensions of the intermediate spaces described above, particularly in the region of undercuts, may be defined with the tool top part. A wide range of shaping possibilities also exists here.

In one advantageous embodiment of the invention, the tool bottom and/or top parts include heating channels, through which the tool bottom part and/or top part may be heated. With heating of the tool parts, the liquid plastics introduced into the receiving mold may be hardened more quickly. In this respect, heating of the tool top part has proven to be especially suitable since the elastic skin inserted into the receiving mold of the tool bottom part is known to conduct heat only poorly.

The molded body produced according to the invention advantageously satisfies a uniform quality standard since it is fully reproducible. In addition, it is distinguished by an improved grained or structured surface, which was not producible by conventional methods.

The molded skin of a molded body firmly bonded therewith preferably has a layer thickness between 0.3 and 5 mm, but particularly between 0.4 and 2 mm.

The invention further relates to the use of a molded body as a component in a vehicle interior, particularly as an instrument panel, door covering or glove compartment cover.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic cross-sectional representation of a closed tool for producing the spatially conformed, elastic silicone skin used in the manufacturing process according to the invention and the device according to the invention;

FIG. 2 shows a schematic cross-sectional representation of the closed tool of FIG. 1, but after a silicone mass has been introduced into the pre-determined intermediate space;

FIG. 3 shows a schematic cross-sectional representation of the positive model with spatially conformed, elastic silicone skin after its removal from the tool bottom part;

FIG. 4 shows a schematic cross-sectional representation of the spatially conformed, elastic silicone skin detached from the positive model;

FIG. 5 shows a schematic cross-sectional representation of the receiving mold of the tool bottom part, into which the elastic silicone skin is inserted;

FIG. 6 shows a schematic cross-sectional representation of the receiving mold of the tool bottom part with inserted elastic silicone skin, to the inside of which a thin layer of paint is applied;

FIG. 7 shows a schematic cross-sectional representation of the receiving mold of the tool bottom part with inserted and painted silicone skin, and a spatially conformed tool top part inserted into the receiving mold of the tool bottom;

FIG. 8 shows a schematic cross-sectional representation of the tool as in FIG. 1, but after a plastic film has been introduced into the intermediate space;

FIG. 9 shows a schematic cross-sectional representation of receiving mold of the tool bottom part with inserted silicone skin, thin layer of paint and the polyurethane molded skin after removal of the tool top part;

FIG. 10 shows a schematic cross-sectional representation of the receiving mold of the tool bottom part with inserted silicone skin, thin layer of paint and molded skin and a tool top with support inserted into the receiving mold;

FIG. 11 shows a schematic cross-sectional representation of the tool as in FIG. 10, but after the introduction of self-foaming polyurethane system,

FIG. 12 shows a schematic cross-sectional representation of the assembly of silicone skin, thin paint layer, polyurethane molded skin, polyurethane foam layer and supports after removal of the tool top part and the receiving mold of the tool bottom part; and

FIG. 13 shows a schematic representation of the finished assembly of a grained polyurethane skin furnished with a layer of paint and a molded body firmly bonded therewith made from polyurethane foam layer and support after removal of the silicone skin.

### DETAILED DESCRIPTION OF THE PREFERRED EMBODIMENT

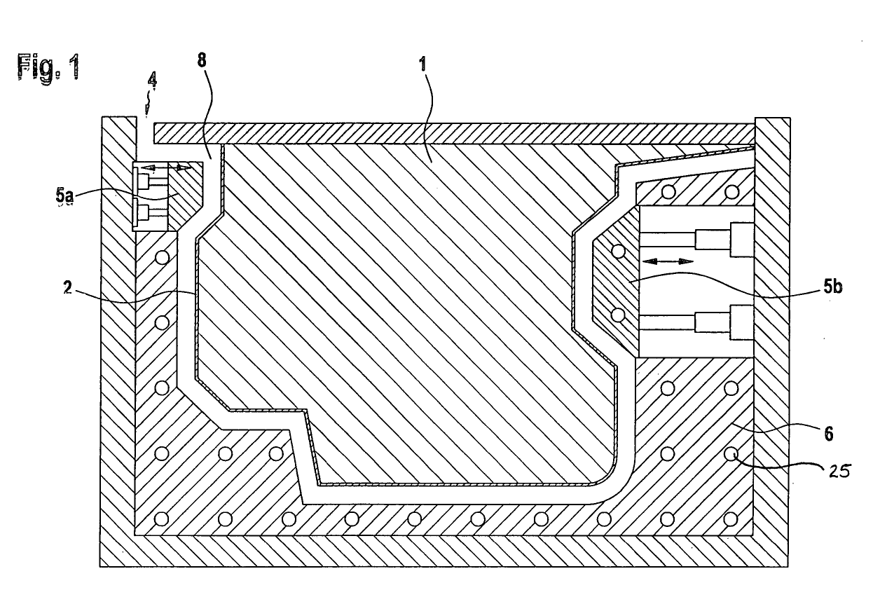

The closed tool represented schematically in FIG. 1 for producing the spatially conformed, elastic silicone skin used in the method and the device according to the invention includes a tool top part, which forms a positive model 1 having grained or structured surface 2, and a spatially conformed tool bottom part 6, into which positive model 2 is introduced. An intermediate space 8 is formed thereby, the dimensions of which are determined by the contours of the tool top part constructed as positive model 1 and by tool bottom part 6. The contours are chosen depending on the molded body, firmly bonded with a grained or structured molded skin that is to be manufactured. Tool bottom part 6 further includes movable elements 5a and 5b, which make it possible to change the contour of tool bottom part 6. In the present case, after positive model 1 is inserted into tool bottom part 6, movable elements 5a and 5b are moved towards positive model 1 so that a uniform intermediate space 8 is formed between positive model 1 and tool bottom part 6. In this way, it is possible to manufacture elastic silicone skins having uniform and reproducible thicknesses. Movable elements 5a and 5b are practical since they allow positive model 1 to be removed from tool bottom part 6 even where undercuts exist without the silicone skin being damaged. For this purpose, movable elements 5a and 5b are simply retracted to their starting position.

An opening 4 provided in the closed tool allows the liquid silicone mass necessary for manufacturing the elastic silicone skin to be introduced into the empty intermediate space 8. Upon hardening, the silicone mass thus introduced forms the elastic silicone skin and creates a high fidelity negative image of positive model 1.

The silicone skin may be manufactured in several layers, in which case it is practical to include reinforcing elements, particularly fabric or fibers as well.

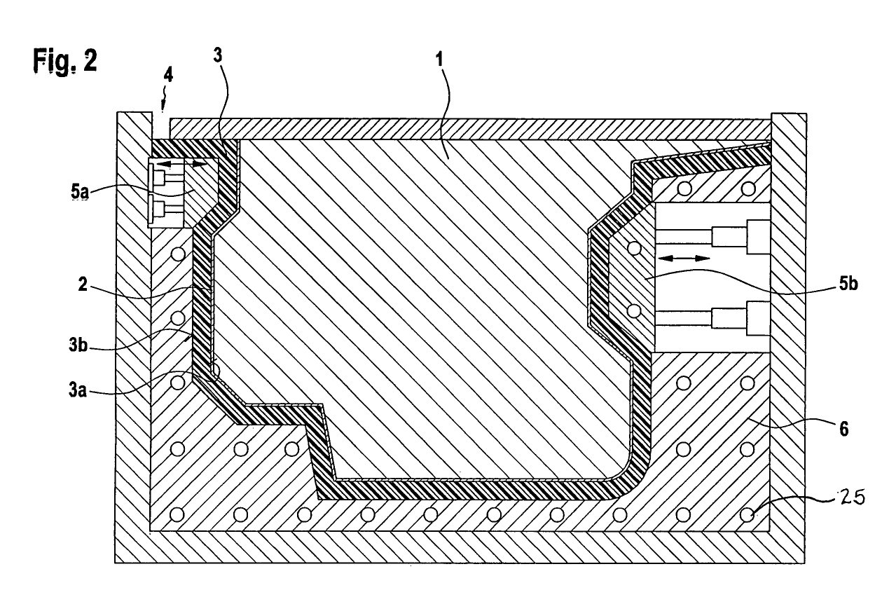

In FIG. 2, the same closed tool is shown as in FIG. 1, but in this case intermediate space 8, which is shown empty in FIG. 1, is filled in FIG. 2 with a silicone mass that is introduced into intermediate space 8 through opening 4. The filler inlets or ventilation openings necessary therefor, which are present but not shown, are disposed depending on the tool geometry. The silicone mass may be introduced into the intermediate space under pressure.

Hardening of the silicone mass to form a spatially conformed, elastic silicone skin 3 may take place at room temperature. However, the purpose of the invention is better served if additional heat is applied to accelerate the hardening of the silicone mass. To this end, tool bottom part 6 may be heated by heating channels 25 extending along tool bottom part 6.

The silicone skin obtained by hardening of silicone mass 3 exhibits on its outside 3b, i.e., the side facing the tool bottom part, an essentially smooth surface. The inside 3a of silicone skin 3, i.e., the side facing positive model 1 exhibits a grained surface. This is a high fidelity negative impression of positive model 1.

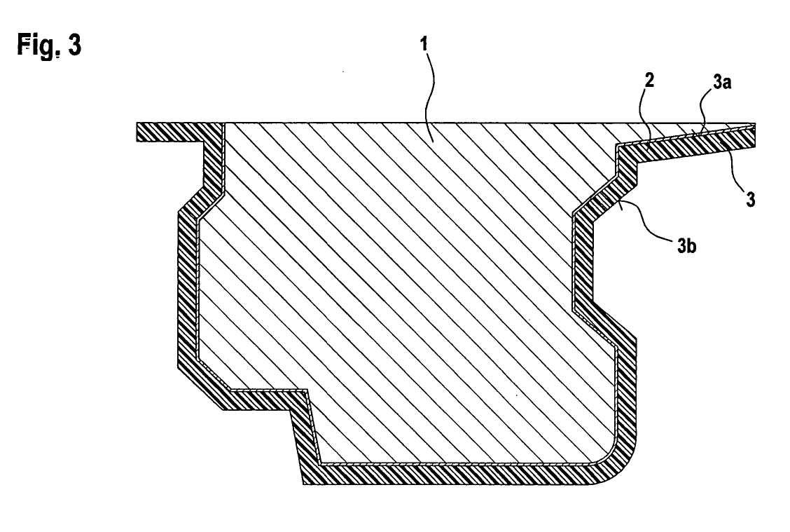

In FIG. 3, positive model 1 is shown with spatially conformed, elastic silicone skin 3 after its removal from tool bottom part 6, as shown in FIGS. 1 and 2. Elastic silicone skin 3 is now obtained by simply stripping it away from positive model 1. Positive model 1 is then available again for manufacturing more elastic silicone skins 3 of the same kind. However, it is also possible to provide the parent model with a new surface graining or structuring, without having to alter the form. In this way, silicone skins 3 of the same shape but with differently grained or structured inside 3a may be produced easily. This is especially advantageous, since it represents a reduction in handling effort and the associated tooling costs.

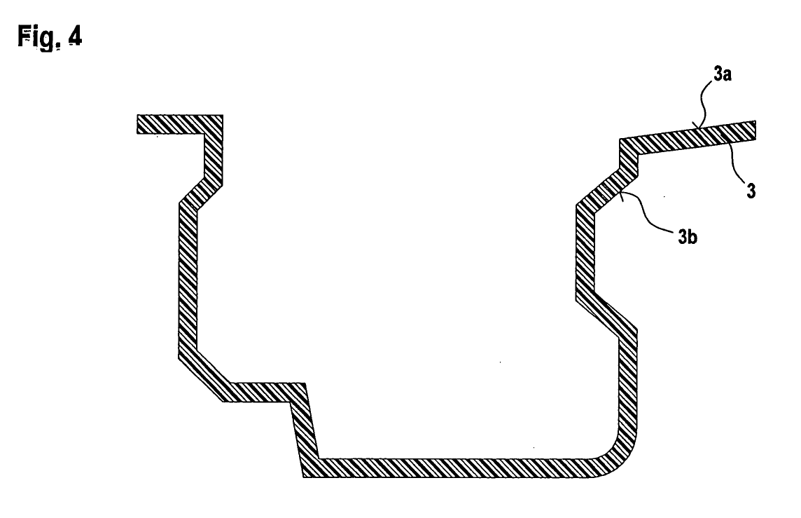

FIG. 4 shows the spatially conformed, elastic silicone skin 3, stripped away from positive model 1, the inside 3a of which is grained while its outside 3b is smooth.

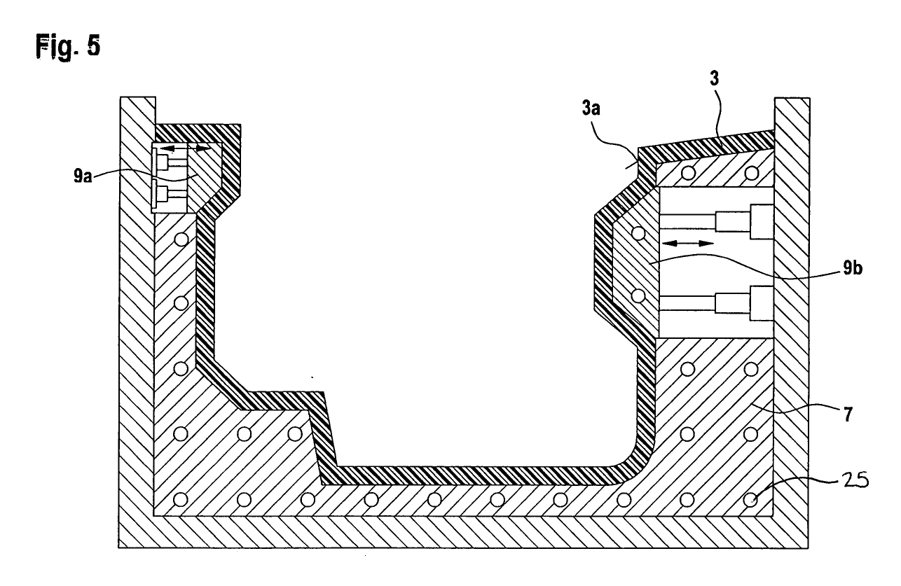

FIG. 5 shows a receiving mold 7, open on one side, of a tool bottom part, into which the spatially conformed, elastic silicone skin 3 is inserted. Elastic silicone skin 3 is placed with its smooth outside 3b facing the inside wall of receiving mold 7 and is stabilized by the inside wall. Stabilization might be assured for example if vacuum devices (not shown) are provided on the inner wall and draw the silicone skin against the inner wall to stabilize it there, it being possible to switch the vacuum on or off at any time.

Receiving mold 7 of the tool bottom part has movable elements 9a and 9b in undercut regions of silicone skin 3. As a result, silicone skin 3 is sufficiently stabilized in the arrangement shown but may also be removed easily from receiving mold 7 in later method steps without damaging silicone skin 3. For this purpose, movable elements 9a and 9b are simply moved away from silicone skin 3.

The arrangement of the movable elements can be freely selected according to the contour of the silicone skin 3 used, since the quality of the molded skin to be produced and of the molded body that is firmly connected to the molded skin is not impaired thereby.

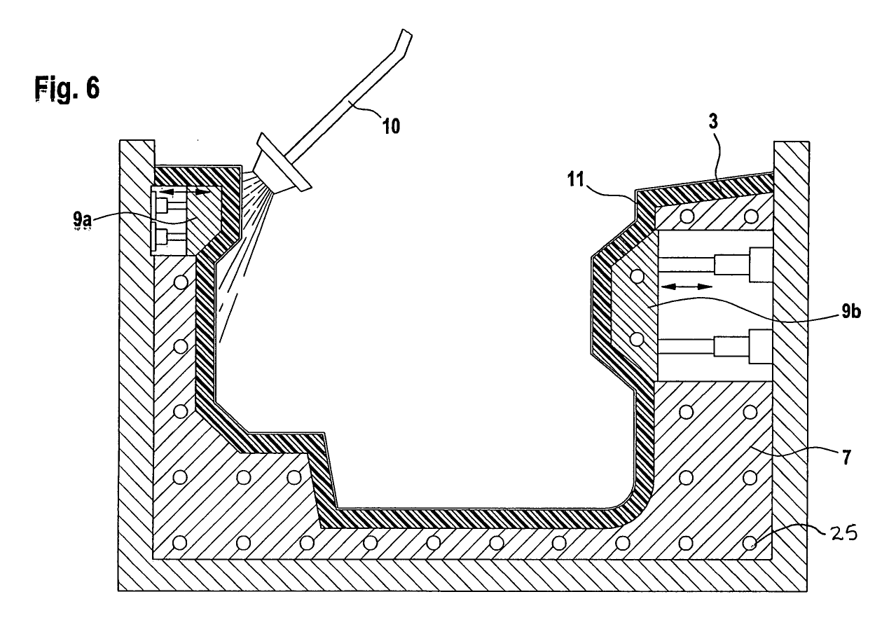

FIG. 6 shows receiving mold 7 of the tool bottom part with inserted elastic silicone skin 3 as shown in FIG. 5. A thin layer of paint 11 is applied to the grained inside 3a of silicone skin 3. This is typically achieved by spraying using a spraying device 10 shown schematically in FIG. 6. This method is also referred to as in-mold-coating.

Suitable paint systems are known in forms that either contain or are free of solvents. Paint layer 11 may dry or harden at room temperature, however in order to accelerate the process, energy is introduced, in particular via heated air or infrared heaters, not shown here.

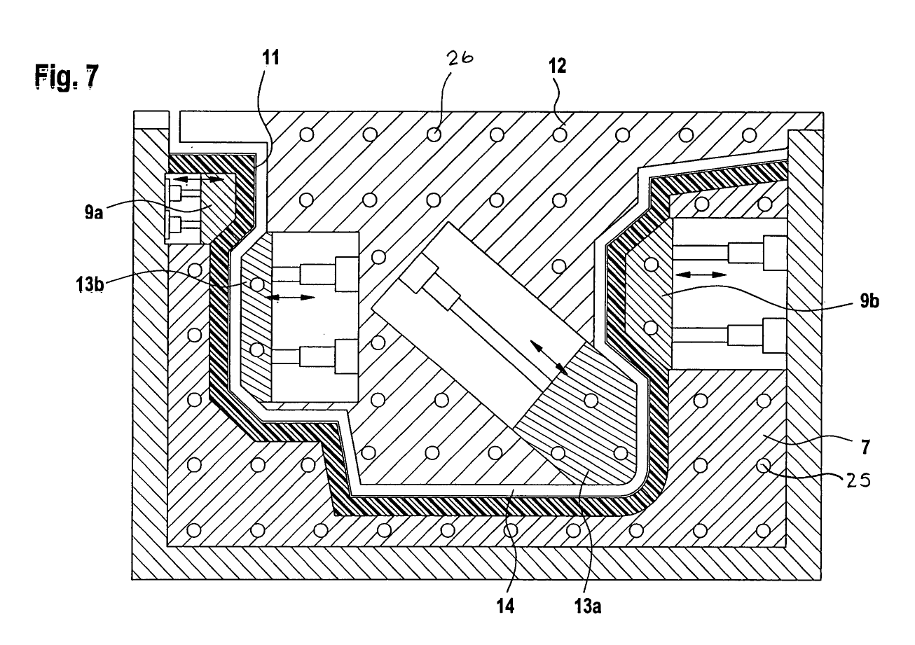

FIG. 7 shows a schematic cross section of receiving mold 7 of the tool bottom part with inserted silicone skin 3, which is provided with a paint layer 11, and of a spatially conformed tool top part 12, which is inserted in receiving mold 7 of the tool bottom part.

The method of applying the liquid plastic film with a predefined film thickness to the grained or structured painted inside 3a of elastic skin 3 as envisaged according to the present invention is realized by pouring or injecting the liquid plastic into an intermediate space 14. Intermediate space 14 is delimited on one side by painted inside 3a of elastic skin 3 and on the other side by a spatially conformed tool top part 12, which is inserted in receiving mold 7 of the tool bottom part, the dimensions of intermediate space 14 being determined by the contours of elastic skin 3 and tool top part 12. In this respect, painted silicone skin 3 effectively forms a female mold and inserted tool top part 12 effectively forms a male mold. Intermediate space 14 accordingly provides the shape for the plastic layer to be applied, the plastic layer forming the molded skin after hardening.

As is shown in FIG. 7, tool top part 12 includes movable elements 13a and 13b. These elements 13a and 13b enable insertion and removal of tool top part 12 into and out of receiving mold 7 of the tool bottom part. When tool top part 12 is inserted, the movable elements are first retracted into tool top part 12. Only when tool top part 12 has reached a predefined position within receiving form 7 of the tool bottom part are movable elements 13a and 13b extended. Extension typically occurs in undercut regions of silicone skin 3, so that entire intermediate space 14 is produced with a uniform height. To remove tool top part 12, movable elements 13 and 13b are returned to their original position. In this way, the molded skin is prevented from being damaged.

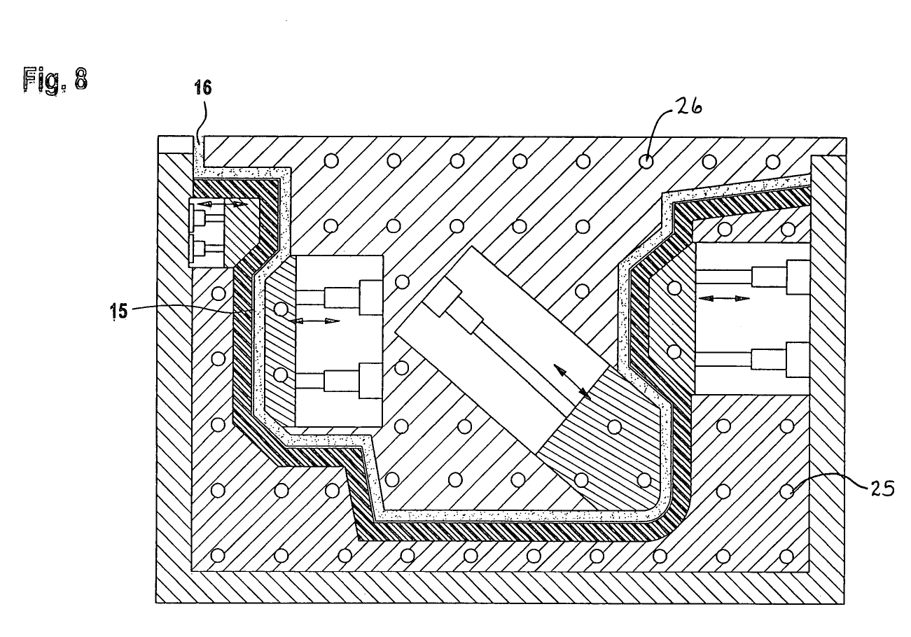

FIG. 8 shows the same tool as in FIG. 1, but after a plastic layer has been inserted into intermediate space 14. The plastic layer is preferably inserted via a filler inlet 16, which is adjacent intermediate space 14. In this context, a liquid, reactive polyurethane substance is preferably used to fill intermediate space 14. For practical reasons, filling occurs under pressure in order to achieve a quick and uniform distribution of the polyurethane mass. Of course, this may also take place via multiple filler inlets 16 as determined by the configuration of the tool. Moreover, at least one ventilation hole, also not shown here and connecting with the intermediate space, is provided.

The purposes of the invention are served if quickly reacting systems are used to produce the plastic layer for rapid creation of the molded skin. A polyurethane reaction system based on aromatic starter materials has proven to be particularly advantageous, though it is practical in this case if paint layer 11 is made from a paint system based on an aliphatic polyurethane. This advantageously ensures the aging resistance of the molded skin.

In a preferred embodiment, the plastic layer introduced into intermediate space 14 is hardened by heat. For this purpose, tool top part 12 may be heated via special heating channels 26 (shown in FIGS. 7 and 8) arranged in tool top part 12. The hardened polyurethane mass then forms molded skin 15.

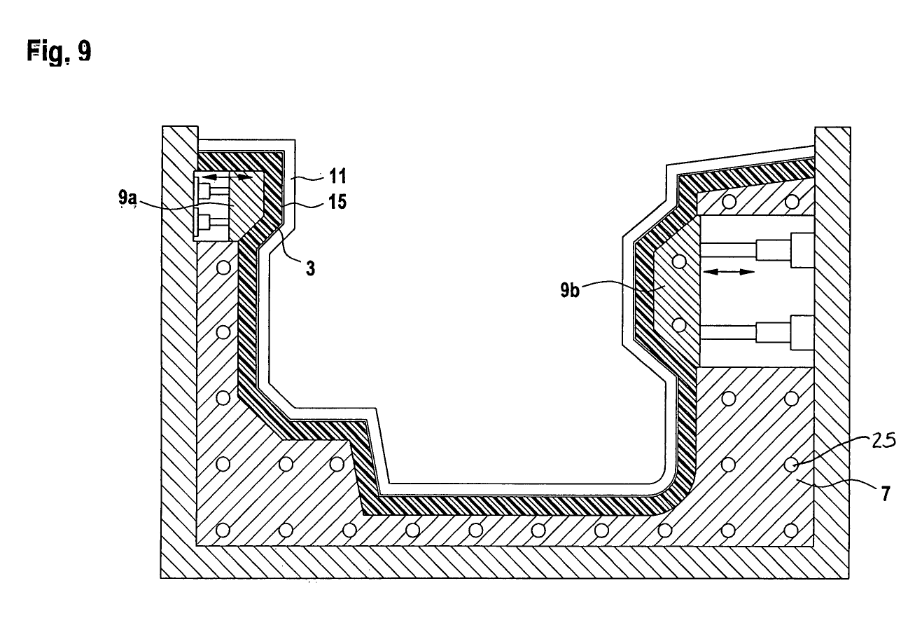

FIG. 9 shows receiving mold 7 of the tool bottom part with inserted silicone skin 3, thin paint layer 11, and polyurethane molded skin 15 after removal of tool top part 12. It is possible to remove polyurethane molded skin 15, which is firmly bonded to thin paint layer 11, from receiving mold 7 of the tool bottom part, at which time silicone skin 3 is either removed at the same time or remains in receiving mold 7 of the tool bottom part.

After the easy separation of the assembly of molded skin 15 and paint layer 11 from silicone skin 3, the side of molded skin 15 provided with paint layer 11 has the same graining or structuring as positive model 1, which is used for producing silicon skin 3. Separated silicone skin 3 may be reused to produce further molded skins 15.

However, silicone skin 3 is first left in receiving mold 7 of the tool bottom part together with the assembly of thin paint layer 11 and molded skin 15, so that it may be foamed, advantageously in the same tool, and provided with a support. This process, referred to as a one-step process, allows the complete production of components of molded skin, foam, and support in one tool, the molded skin also being able to be painted as described above.

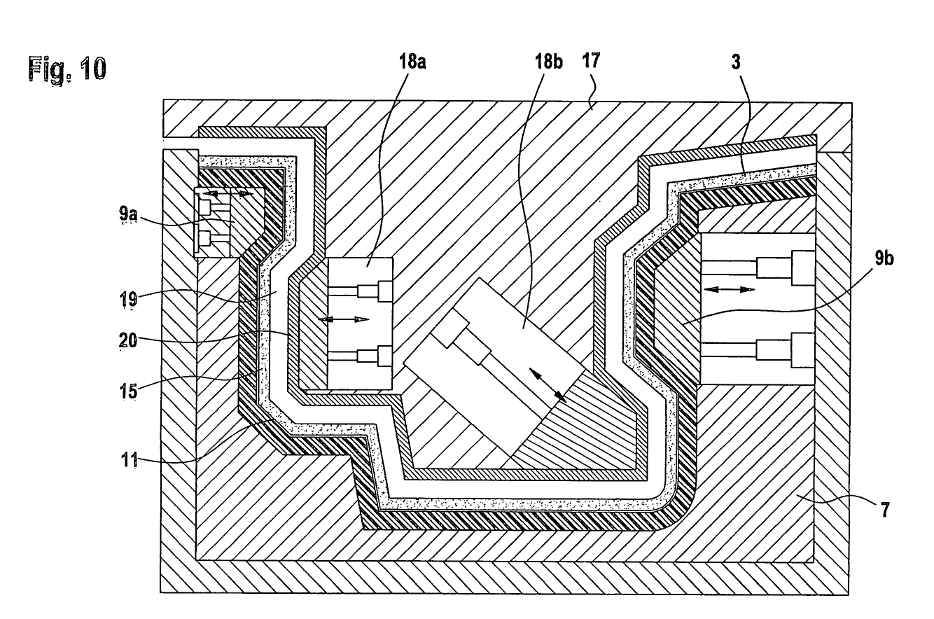

FIG. 10 shows receiving mold 7 of the tool bottom part with inserted silicone skin 3, thin paint layer 11, molded skin 15, and a tool top part 17, which is inserted in the receiving mold and has a support 20.

The arrangement shown in FIG. 10 is used on the one to provide foam backing for molded skin 15 to form the molded body and to create a firm bond between support 20, which is detachably attached to tool top part 17, and the foam to be produced, together forming the molded body, and between the molded body and molded skin 15.

In this step, suitable reactive foaming agents are introduced into intermediate space 19, which is delimited by the inside of molded skin 15 and spatially conformed support 20, which is detachably attached to tool top part 17. The dimensions of intermediate space 19 are determined by the contours of molded skin 15 and support 20.

Support 20 may be detachably attached, for example, via a vacuum to tool top part 17, tool top part 17 including at least one vacuum device not shown here.

Tool top part 17 also includes movable elements 18a and 18b, which allow the simple and damage-free removal of tool top part 17 from receiving mold 7, provided that elements 18a and 18b are moved into a position in which they are retracted into tool top part 17.

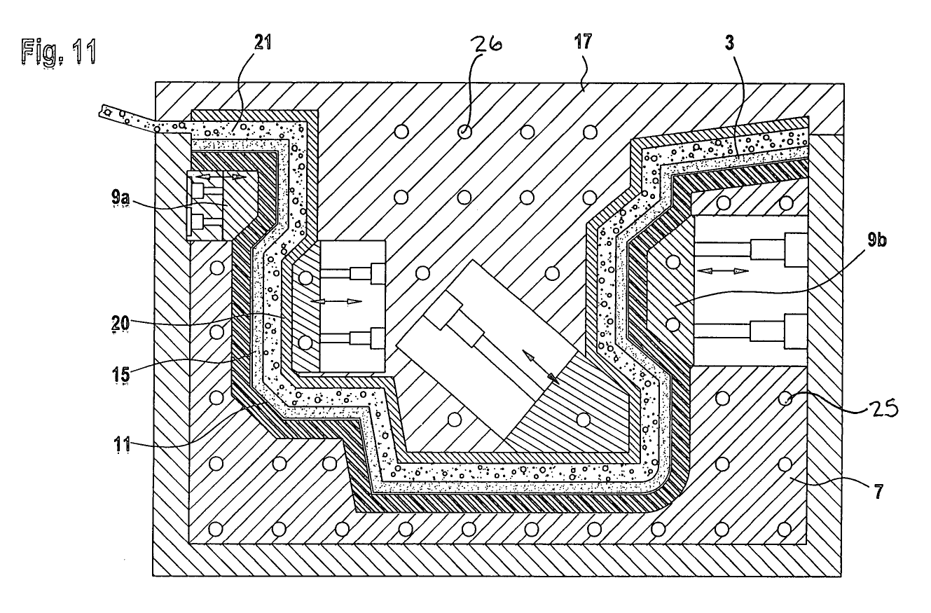

FIG. 11 shows the same arrangement as FIG. 10, but following the introduction of a self-foaming polyurethane system that hardens into a solid foam 21, and thereby forms a solid assembly of molded skin 15, which is provided with paint layer 11, foam layer 21, and support 20.

The foaming system is introduced into intermediate space 19 using pressure via an opening adjacent intermediate space 19 or is poured directly into the open tool, in which case tool top part 17 must be moved directly into the position shown in FIG. 11 prior to foaming.

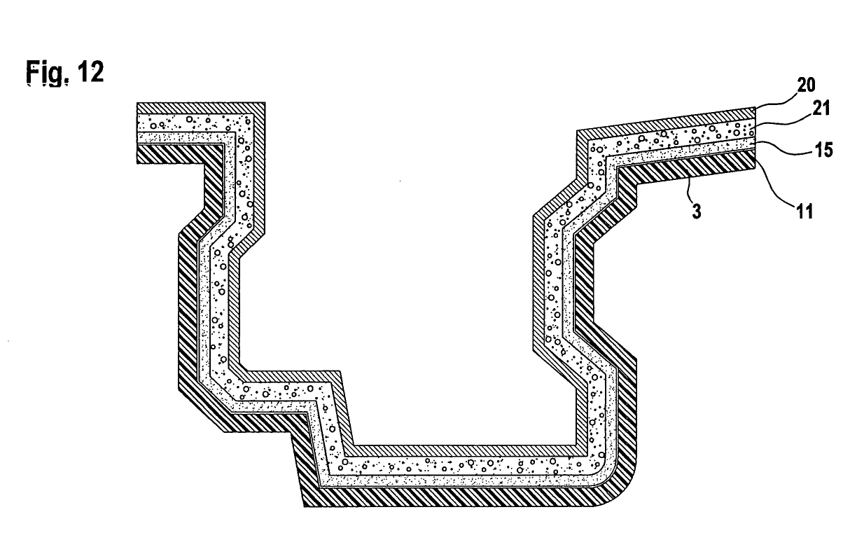

FIG. 12 shows the arrangement of silicone skin 3, thin paint layer 11, polyurethane molded skin 15, polyurethane foam layer 21, and support 20 that was withdrawn from receiving mold 7, after removal of tool top part 17. The advantageously dehesively acting silicone skin 3 can easily be stripped from the produced assembly of support 20, polyurethane foam 21, molded skin 15, and paint layer 11.

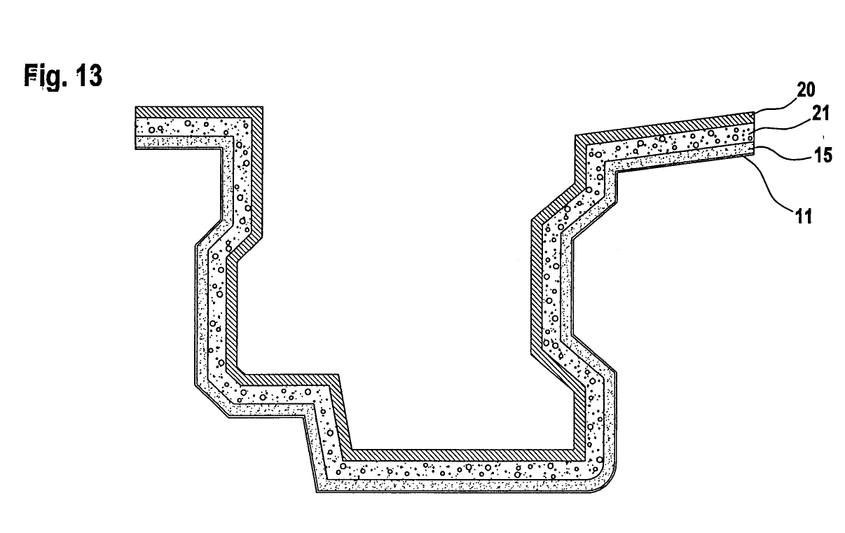

Removal of silicone skin 3 yields the assembly shown in FIG. 13 of a grained polyurethane molded skin 15, which is provided with a paint layer 11, and a molded body of polyurethane foam layer 21 and support 20, the molded body being firmly connected to the polyurethane molded skin. The removed and still undamaged silicone skin 3 may be reused immediately to produce a new molded body firmly bonded to a grained and optionally painted molded skin.

Accordingly, while only a few embodiments of the present invention have been shown and described, it is obvious that many changes and modifications may be made thereunto without departing from the spirit and scope of the invention.

What is claimed is:

1. A method for producing a molded body firmly bonded to a grained or structured molded skin, comprising the following steps:
a) inserting a spatially conformed, elastic skin having a graining or structuring on an inside thereof, into a receiving mold open on one side of a tool bottom part so that an outside of the elastic skin abuts and is stabilized by an inner wall of the receiving mold;
b) applying a liquid plastic film with a predefined film thickness to the grained or structured inside of the elastic skin;
c) hardening the plastic film so that a molded skin is formed;
d) back-foaming the molded skin to form the molded body and forming a firm bond between the molded body and the molded skin by introducing reactive foaming agents into an intermediate space that is delimited by an inside of the molded skin and a spatially conformed tool top part, which is inserted into the receiving mold of the tool bottom part, the dimensions of the intermediate space, and thus also of the foam that forms the molded body, being defined by contours of the molded skin and the tool top part, and the intermediate space being sealed off from the tool top part during foaming;
e) removing the elastic skin, molded skin, and the molded body all together in a single assembly from the receiving mold of the tool bottom part, the tool top part being removed either before or after the removal of the assembly; and
f) stripping the elastic skin from the molded skin, which is firmly bonded with the molded body, so that a graining or structuring remains on the surface of the molded skin after the elastic skin is stripped away.

2. The method according to claim 1, wherein the tool top part includes a detachable and spatially conformed support, which at least partially delimits the intermediate space instead of the tool top part, the dimensions of the intermediate space being defined by the contours of the molded skin and at least partially by the support, and wherein the assembly of elastic skin, molded skin, and the molded body with the support embedded therein is removed from the receiving mold of the tool bottom part, the tool top part being detached and removed from the support either before or after removal of the entire assembly.

3. The method according to claim 1, wherein the reactive foaming agents comprise raw materials that form open-cell polyurethane foams.

4. The method according to claim 1, wherein the step of back-foaming takes place under the influence of heat, and wherein the tool top part is heated via at least one heating channel extending in tool top part.

5. A method for producing a molded body firmly bonded with a grained or structured molded skin, comprising the following steps:
a) inserting a spatially conformed, elastic skin having a graining or structuring on an inside thereof, into a receiving mold of a tool bottom part that is open on one side, in such a manner that an outside of the elastic skin abuts and is stabilized by an inner wall of the receiving mold;
b) applying a liquid plastic film with a predefined film thickness to the grained or structured inside of the elastic skin;
c) hardening the plastic film to form the molded skin;
d) bonding a molded body configured as a support to the molded skin by applying a primer and/or adhesive to an inside of the molded skin, and pressing the support, which is formed as a detachable part of a tool top part onto the molded skin to which the primer and/or adhesive has been applied, thereby forming a firm bond between the support and the molded skin;
e) removing the elastic skin, molded skin, and the molded body in a single assembly from the receiving mold of the tool bottom part, the tool top part being detached and removed from the molded body either before or after removal of the assembly; and
f) stripping the elastic skin from the molded skin which is firmly bonded to the molded body, so that a graining or structuring remains on the surface of the molded skin after the elastic skin has been stripped away.

6. A method for producing a molded body firmly bonded with a grained or structured molded skin, comprising the following steps:
a) inserting a spatially conformed, elastic skin having a graining or structuring on an inside thereof into a receiving mold of a tool bottom part that is open on one side, in such a manner that an outside of the elastic skin abuts and is stabilized by an inner wall of the receiving mold;
b) applying a liquid plastic film with a predefined film thickness to the grained or structured inside of the elastic skin;
c) hardening the plastic film to form the molded skin;
d) bonding a molded body configured as a support to the molded skin by pressing the support onto the not yet completely hardened plastic film, such that a firm bond between the support and the molded skin is created when the plastic film has fully hardened;
e) removing the elastic skin, molded skin, and the molded body in a single assembly from the receiving mold of the tool bottom part, the tool top part being detached and removed from the molded body either before or after removal of the assembly; and
f) stripping the elastic skin from the molded skin which is firmly bonded to the molded body, so that a graining or structuring remains on the surface of the molded skin after the elastic skin has been stripped away.

7. The method according to claim 1, wherein the elastic skin stripped off is reused directly in method step a).

8. The method according to claim 1, wherein the liquid plastic film is applied with a predefined film thickness to the grained or structured inside of the elastic skin by pouring or injecting the liquid plastic into an intermediate space, which is delimited by the inside of the elastic skin and tool top part that is inserted into the receiving mold of the tool bottom part, the dimensions of the intermediate space being defined by the contours of the elastic skin and the tool top part, and the tool top part is removed from the receiving mold of the tool bottom part after the plastic layer at least partially hardens.

9. The method according to claim 8, wherein the plastic film hardens under the influence of heat, the tool top part being heated via at least one heating channel extending in the tool top part.

10. The method according to claim 1, wherein the plastic film is made from a material selected from the group consisting of: cross-linkable polyurethanes, polyurethane molding resins, liquid cross-linkable substances, epoxy resins, non-reactive hot-melt substances, thermoplastic polyurethanes (TPU), thermoplastic polyolefins (TPO), thermoplastic elastomers (TPE), polyvinyl chloride (PVC) and mixtures thereof.

11. The method according to claim 1, wherein the plastic film is formed from a single- or multi-component, cross-linkable polyurethane system that is based on aliphatic or aromatic starter materials.

12. The method according to claim 1, wherein after performing step a) a thin paint layer is applied as an in-mold coating to the grained inside of the elastic skin and is dried or hardened, and method step b) is subsequently performed, the liquid plastic film being applied to the thin paint layer.

13. The method according to claim 12, wherein different regions of the inside of the elastic skin are coated with different coloured paints.

14. A device for manufacturing a molded body firmly bonded to a grained or structured molded skin, comprising a spatially conformed, elastic skin having a graining or structuring on an inside thereof, said skin being formed from a flexible elastomer polyurethane or rubber skin.

15. The device according to claim 14, further comprising reinforcing elements arranged in the elastic skin.

16. The device according to claim 14, wherein the spatially conformed, elastic skin is produced by applying a liquid silicone prepolymer to a grained or structured positive model and then cross-linked by an addition and/or condensation reaction, and subsequently stripped away from the positive model, the elastic skin representing a spatially conformed negative image of the molded skin to be produced and having on its inside a corresponding graining or structuring.

17. The device according to claim 16, wherein the elastic skin is made of silicone and wherein silicone is removed from the outside of the skin that has been stripped from the positive model until a predefined layer thickness of the skin is obtained.

18. The device according to claim 16, wherein the elastic skin is produced by introducing the liquid silicone prepolymer into an intermediate space of a closed tool, delimited by a tool top part mirroring the positive model and a spatially conformed tool bottom part positioned over the positive model, the dimensions of the intermediate space being defined by the contours of the tool bottom part and the tool top part, wherein cross-linking to the silicone skin occurs after introduction of the silicone prepolymer into the intermediate space.

19. The device according to claim 14, wherein the elastic skin has a layer thickness between 0.8 and 10 mm.

20. The device according to claim 14, further comprising a tool bottom part forming a receiving cavity, wherein the tool bottom part is constructed in several parts and includes movable elements.

21. The device according to claim 20, further comprising a tool top part mirroring the positive model, said tool top part being constructed in several pieces and including movable elements.

22. The device according to claim 21, wherein the tool top or bottom parts include heating channels via which the tool top or bottom part can be heated.

23. A molded body firmly bonded to a grained or structured and painted molded skin, produced via a method according to claim 1.

24. A molded body firmly bonded to a grained molded skin and produced via a method according to claim 8, the molded skin having a layer thickness between 0.3 and 5 mm.

25. The method according to claim 5, wherein the elastic skin stripped off is reused directly in method step a).

26. The method according to claim 5, wherein the liquid plastic film is applied with a predefined film thickness to the grained or structured inside of the elastic skin by pouring or injecting the liquid plastic into an intermediate space, which is delimited by the inside of the elastic skin and tool top part that is inserted into the receiving mold of the tool bottom part, the dimensions of the intermediate space being defined by the contours of the elastic skin and the tool top part, and the tool top part is removed from the receiving mold of the tool bottom part after the plastic layer at least partially hardens.

27. The method according to claim 26, wherein the plastic film hardens under the influence of heat, the tool top part being heated via at least one heating channel extending in the tool top part.

28. The method according to claim 5, wherein the plastic film is made from a material selected from the group consisting of: cross-linkable polyurethanes, polyurethane molding resins, liquid cross-linkable substances, epoxy resins, non-reactive hot-melt substances, thermoplastic polyurethanes (TPU), thermoplastic polyolefins (TPO), thermoplastic elastomers (TPE), polyvinyl chloride (PVC) and mixtures thereof.

29. The method according to claim 5, wherein the plastic film is formed from a single- or multi-component, cross-linkable polyurethane system that is based on aliphatic or aromatic starter materials.

30. The method according to claim 5, wherein after performing step a) a thin paint layer is applied as an in-mold coating to the grained inside of the elastic skin and is dried or hardened, and method step b) is subsequently performed, the liquid plastic film being applied to the thin paint layer.

31. The method according to claim 30, wherein different regions of the inside of the elastic skin are coated with different coloured paints.

32. The method according to claim 6, wherein the elastic skin stripped off is reused directly in method step a).

33. The method according to claim 6, wherein the liquid plastic film is applied with a predefined film thickness to the grained or structured inside of the elastic skin by pouring or injecting the liquid plastic into an intermediate space, which is delimited by the inside of the elastic skin and tool top part that is inserted into the receiving mold of the tool bottom part, the dimensions of the intermediate space being defined by the contours of the elastic skin and the tool top part, and the tool top part is removed from the receiving mold of the tool bottom part after the plastic layer at least partially hardens.

34. The method according to claim 33, wherein the plastic film hardens under the influence of heat, the tool top part being heated via at least one heating channel extending in the tool top part.

35. The method according to claim 6, wherein the plastic film is made from a material selected from the group consisting of: cross-linkable polyurethanes, polyurethane molding resins, liquid cross-linkable substances, epoxy resins, non-reactive hot-melt substances, thermoplastic polyurethanes (TPU), thermoplastic polyolefins (TPO), thermoplastic elastomers (TPE), polyvinyl chloride (PVC) and mixtures thereof.

36. The method according to claim 6, wherein the plastic film is formed from a single- or multi-component, cross-linkable polyurethane system that is based on aliphatic or aromatic starter materials.

37. The method according to claim 6, wherein after performing step a) a thin paint layer is applied as an in-mold coating to the grained inside of the elastic skin and is dried or hardened, and method step b) is subsequently performed, the liquid plastic film being applied to the thin paint layer.

38. The method according to claim 37, wherein different regions of the inside of the elastic skin are coated with different coloured paints.
